(19) United States
(12) Patent Application Publication
(10) Pub. No.: US 2025/0164126 A1
(43) Pub. Date: May 22, 2025

(54) ELECTRODE STEAM HUMIDIFIER AND METHOD FOR ITS OPERATION

(71) Applicant: HygroMatik GmbH, Henstedt-Ulzburg (DE)

(72) Inventor: Michael Lütkemann, Henstedt-Ulzburg (DE)

(21) Appl. No.: 18/838,828

(22) PCT Filed: Feb. 16, 2023
(86) PCT No.: PCT/EP2023/053827

§ 371 Date: Aug. 15, 2024

(51) Int. Cl. F24F 6/02; H05B 3/22

(52) U.S. Cl. CPC F24F 6/025; H05B 3/22

(57) ABSTRACT

The invention relates to an electrode steam humidifier (1), a method for operating the same as well as a suitable computer program product for executing the method. The electrode steam humidifier (1) comprises a steam container (2) with a first water inlet (10) for mineralized water and at least two electrodes (6) arranged to be at least partly immersed in water filled in above a minimum fill level, wherein the electrodes (6) are supplied with an electric voltage so that at least one of the electrodes (6) has a different potential than the other electrode(s) (6) to cause an electric current in the water, wherein the steam container (2) comprises a second water inlet (11) for demineralized water and means to assess the conductivity of the water held within the steam container (2), wherein the throughflow through both water inlets (10, 11) for replenishing the steam container (2) is controlled by a controller (20) based on the assessed conductivity in order to obtain or maintain a desired conductivity. In the method for operating an electrode steam humidifier (1), the conductivity of the water within the steam container (2) of the steam humidifier (1) is assessed and the conductivity of water introduced into the steam container (2) for replenishment is adjusted so that the resulting water mixture in the steam container (2) has a desired conductivity. The inventive computer program product comprises program parts that are designed, when loaded in a digital controller connected to the required sensors and actuators of at least an electrode steam humidifier, to execute the inventive.

### BACKGROUND

The invention relates to an electrode steam humidifier and a method for operating the same as well as a suitable computer program product for executing the method.

Known electrode steam humidifiers comprise a steam cylinder with electrodes protruding therein. If sufficiently filled with tap water, a sufficient electric voltage applied to the electrode will lead to a current flow through the water that eventually leads to boiling the water, thus generating steam. The decrease in water level due to the extracted steam is balanced by refilling tap water to a prescribed level, typically in an intermittent fashion once the water level has lowered to a certain extent. Apart from a possible maximum fill level sensor that limit the water intake to the prescribed level, the water level within the steam cylinder is generally regulated based on the electrical power consumed by the steam generation.

Due to the generated steam being pure and the mineral substances originally dissolved in the tap water remaining in the steam cylinder, the concentration of said mineral substances in the water within the steam cylinder increases. While dissolved mineral substances are essential for the electrode steam humidifiers to work, since they provide for the required conductivity, the increase in said mineral concentration has some severe disadvantages. As the increase in the mineral concentration leads to an increase in conductivity of the water, this leads to an increased corrosion of the electrodes and increased formation of lime scale.

To keep these disadvantages in check and to ensure operability of the electrode steam humidifiers, the steam cylinder needs to be fully drained regularly for the highly saline water to be exchanged with fresh tap water. Any precipitating mineral residues must also be regularly removed, e.g. either during the draining process or during regular maintenance cycles.

### SUMMARY

It is an object of the present invention to provide an electrode steam humidifier, a method for operating an electrode steam humidifier and a corresponding computer program product, where these disadvantages are at least mitigated.

This object is solved by an electrode steam humidifier a method as well as a computer program product according to the independent claims. Preferred embodiments are subject of the dependent claims.

The invention thus relates to an electrode steam humidifier comprising a steam container with a first water inlet for mineralized water and at least two electrodes arranged to be at least partly immersed in water filled in above a minimum fill level, wherein the electrodes are supplied with an electric voltage so that at least one of the electrodes has a different potential than the other electrode(s) to cause an electric current flow in the water, wherein the steam container comprises a second water inlet for demineralized water and means to assess the conductivity of the water held within the steam container, wherein the throughflow through both water inlets for replenishing the steam container is controlled by a controller based on the assessed conductivity in order to obtain or maintain a desired conductivity.

Furthermore, the invention relates to a method for operating an electrode steam humidifier, wherein the conductivity of the water within the steam container of the steam humidifier is assessed and the conductivity of water introduced into the steam container for replenishment is adjusted so that the resulting water mixture in the steam container has a desired conductivity.

The invention also relates to a computer program product comprising program parts that are designed, when loaded in a digital controller connected to the required sensors and actuators of at least an electrode steam humidifier, to execute the inventive method.

Before explaining the invention in detail, some definitions of terms used in context with the present invention are provided.

Electrodes have “different potential” if their electric potential is generally and intentionally not the same, which is self-explanatory for direct voltages applies to the electrodes. In case of applying an alternate or multiphase voltage to the electrodes of an electrode steam humidifier, the electrodes are still considered to be different potential, even if during a cycle the electric potential might momentarily be the same but is different for most of the cycle.

The present invention has recognized that by selectively refilling water with different degrees of purity allows for a certain control over the conductivity of the water held within an electrode steam humidifier, which—as a result—can be operated with high efficiency over longer operating cycles than is possible with known electrode steam humidifier. In particular, the maintenance cycles of electrode steam humidifiers according to the invention can be significantly extended in comparison to what is common in the current state of the art, since the degradation of the electrodes as well as the precipitating of mineral can be reduced significantly by maintaining a prescribed level of mineralization of the water within the steam container.

To achieve this, a controller controls the inflow of either mineralized water (such as tap water) and demineralized water to ensure a desired conductivity of the water held within the steam container is either obtained or maintained at least within a certain tolerance range, in order to counter the effects of steam extractions (generally increasing the conductivity) and the precipitating of mineral (generally decreasing the conductivity). The overall inflow as well as the mixing ratio of the inflow of mineralized and demineralized water is to be based on the conductivity that is assessed for the water already present in the steam container.

It has been found that the conductivity can already be assessed to a level sufficiently accurate by observing the system response to certain changes in the system state, taking into account certain system constants and, if necessary, certain presumptions. For this, it is preferred that the means to assess the conductivity of the water held within the steam container comprise an observer module capable of observing various parameters of operation of the electrode steam humidifier that are sufficient to assess said conductivity. Said observer module might be integrated into the controller.

For example, if the steam container is filled for the first time with either only mineralized water via the first water inlet or a prescribed mixture of mineralized and demineralized water via both water inlets to a prescribed level, the system response to applying a prescribed electric voltage to the electrodes may be regarded as the desired reference response.

The system response might be observed by measuring the electric currents resulting from applying the prescribed electric voltage. Over time, the system will first show an increase in conductivity, visible as an increase in electric currents while the water is warming up until boiling. Afterwards, due to water evaporating the water level within the steam container will slowly drop, resulting in a reduction of the electrode surfaces immersed in the water and a subsequent decrease in the electric currents. Replenishing the steam container with water with the initial conductivity (e. g. by using only water from the first inlet or from both inlets in the initially used mixing ratio) once the electric currents hit a lower threshold, will result in a renewed increase in the electric currents, depending on the temperature of the inflowing water, first possibly due to the refilling, then due to the subsequent temperature rise evoked by the electric current flowing through the water. Of course, depending on the selection of the lower threshold, the replenishing of water may approximate a continuous flow of water.

Since the changes in mineralization of the water within the steam container—and thus in its conductivity—over the first or the first few cycles as described are negligible, the system response in this initial first or first few cycles may be regarded as a reference response. This reference response may be—e. g. digitally—stored as reference response data and accessibly by the controller and/or the observer module.

Assuming relevant environmental and system parameters remain constant—such as the mineral concentration in the mineralized and demineralized water at the first and second inlet as well as the temperature of any inflowing water—any ascertainable deviation from the reference response during operation points to a change in the conductivity of the water within the steam container.

At that point, the mixture ratio of mineralized and demineralized water for replenishing the steam container may be systematically adjusted to move the overall conductivity of the water within the steam container towards the conductivity the reference response is based on. The change in the mixture radio might e.g. be prescribed by means of a characteristic curve accessibly to the controller and/or observer module, e. g. digitally stored, or by means of mathematic equations. It may also be derived from a modelization of the system.

While it is, as outlined, possible to individually determine the reference response for each electrode steam humidifier in its intended operating environment, it is, of course, also possible to provide the controller and/or observer module with previously created reference response data. The reference response data for a specific electrode steam humidifier and/or its operating environment may be calculated or selected from a suitable reference response data catalogue based on certain parameters, e.g. the structural design of the electrode steam humidifier, especially regarding the number and arrangement of the electrodes, or the mineral concentration of the water fed through the first water inlet.

Furthermore, it is also possible that the controller and/or the observer module comprises a machine learning algorithm to, over time and e.g. starting with a prescribed characteristic curve for adjustment of the mixture ratio of mineralized and demineralized water, determine the most suitable mixture adjustments in case of deviations from the reference response.

While it is—as explained—possible to control the conductivity of the water within the steam container solely by evaluating system responses during operation with sufficient accuracy, the conductivity control can further be enhanced by relying on additional sensor information, thus reducing the dependency on indirectly determined or assumed values. Said additional sensor information may be fed to the observer module and considered when assessing any current system response in comparison with a reference response. Potentially, it is also possible to have all relevant parameters for assessing the conductivity of the water held within the steam container collected by suitable sensors directly. In this case, the observer module might be omitted and all measured values are directly processed by the controller.

The electrode steam humidifier may preferably comprise a sensor electrode that indicates the water level within the steam container being at or above a prescribed level. For this, the tip of the sensor electrode is arranged at the prescribed level, wherein the detection value of the sensor depends on the sensor tip being immersed in the water or above the water level. Such sensor electrodes are generally known in the prior art and e.g. already used as maximum water level indicators.

Any switch over between these two detection states of the sensor electrode, may be interpreted by the controller as a signal that the water level within the steam container has reached or is at the prescribed level, or is lower than said level. Any deviation from the expected reference response of the system with this specific water level may then be interpreted to be caused by other changes to the system, such as a change in conductivity of the water.

The sensor electrode is preferably configured to detect the water level at the level the steam container is to be regularly refilled to, when compensating for the water losses due to steam generation. The sensor electrode may then also be used as an indicator for stopping any water inflow though the water inlets, without affecting its function described above.

While the sensor electrode operates reliably in most cases, the quality of the water to be used in the electrode steam humidifier, especially the quality of the mineralized water at the first water inlet, under certain circumstances might result in the formation of foam within the steam container, especially during replenishment or when the water is boiling. Since foam might lead to incorrect sensor electrode readings, it is preferred that in addition or as an alternative to a sensor electrode, a water level detector may be provided that is, preferably, not or at least less susceptible to misreading due to foam. A water level detector—in contrast to a sensor electrode—is not only capable of detecting whether the water level is below or above a prescribed level, but rater capable of determining any water level within its measuring range. It may be one or more reed contacts actuated by a flotation body in a separate container in communication with the steam, or a capacitive water level sensor, e.g. as disclosed in DE 20 2016 005 944 U1. In order to avoid or at least reduce any possible interference of e.g. foam formation on a water level detector, said detector may be located in a container separate from the steam container, wherein said containers form communicating vessels. In such a configuration, foam formation or any other effects occurring when boiling water that could affect the measurement accuracy of a water level sensor is generally limited to the steam container and the water level sensor located in the separate container is unaffected.

In a preferred embodiment, a conductivity sensor may be provided in the steam container or in a vessel communicating therewith. The sensor is preferably located at a position that is below typical water levels during normal operation of the electrode steam humidifier. By providing a conductivity sensor, the conductivity of the water does not need to be determined indirectly by measuring the electric currents resulting from applying the prescribed electric voltage to the electrodes, which might be more susceptible to errors than a direct conductivity measurement, e. g. wear of the electrodes.

Alternatively, or in addition, a conductivity sensor may also be provided at one or both of the water inlets and/or at a position, where the two separate inlets are united to provide a combined inflow of already mixed water. With a conductivity sensor at the inflow, the quality of the mineralized water, demineralized water and/or mixture thereof can be observed and taken into account by the controller, e. g. adjusting the inflow through both inlets to obtain the desired conductivity of the mixture of water.

Preferably, the electrodes and/or their numbers are optimized to allow the electrode steam humidifier to allow the conductivity of the water to be as low as possible. A preferred number of electrodes for a steam output of up to 15 kg/h is 3, for a steam output of 20 to 65 kg/h 6 electrodes are preferred. The surface of the electrodes as a function of the rated current is preferably between 5 and 30 cm²/A, more preferably between 10 and 20 cm²/A for full-surface electrodes, or preferably between 5 and 25 cm²/A, more preferably between 5 and 15 cm²/A for mesh electrodes, the full-surface electrodes, however, being preferred. The surface distance between two adjacent electrodes with different potentials is preferably between 25 and 50 mm for a maximum rated potential difference of 400V (e.g., occurring with alternating currents), between 15 and 35 mm for a maximum rated potential difference of 200V, or between 50 and 80 mm for a maximum rated potential difference of 690V.

The electrode steam humidifier may comprise solenoid or motorized valves on the first and/or the second water inlet that are controllable by the controller. Alternatively, in case the demineralized water comes from an external water treatment device, the electrode steam humidifier may comprise an interface to the external water treatment device connected to the second water inlet to control the demineralized water output of the water treatment device.

As has already been explained, applying electric voltage to the electrodes will lead to electric currents within the water that will heat up the water and thus changing its conductivity. The electric currents will also rise until the water is boiling and a maximum in steam production achieved. Once boiling, steam is extracted, which lowers the water level in the steam container and subsequently decreases the steam production. Once the steam container is replenished, the cycle starts anew with an increase in steam production up to its maximum. Typically, in known electrode steam humidifiers depending on the actual design these variations in steam production over a full replenishment cycle can be up to ±2.5% or even ±10% around a given set point, either predefined by the structural configuration of the electrode steam humidifiers or predetermined by setting various process parameters, like voltage, maximum currents and/or power.

In order to reduce said variations, the controller is preferably configured to control the steam production of the electrode steam humidifier more finely.

For this, the controller might be configured to regulate the electric power that is conducted through the electrodes. Especially, the controller might limit or mitigate the increase in electric current due to an increase in conductivity of the water in order to regulate the steam generation. This way, an overshoot in steam generation when boiling up water can be avoided or at least reduced. For regulating the electric power, any know technology, such as pulse-width modulation (PWM), AC-to-AC-conversion, leading-edge cutoff or trailing-edge cutoff, may be used.

In case of a water level detection present, the controller might also be configured to control the steam production based on the water level, which corresponds to the immersion depth of the electrodes. In comparison to a sensor electrode, a water level detector allows for more precise replenishing of water to reduce the variation in water level during operation. Less variation in water level also means less variation in steam production.

For an explanation of the method according to the present invention, it is generally referred to the above.

In the inventive method for operating an electrode steam humidifier, the conductivity of the water within the steam container of the steam humidifier is assessed, wherein the assessment might be based on observing system responses, direct and/or indirect measurements. The conductivity of water introduced into the steam container for replenishment, as is generally required during operation of an electrode steam humidifier, is adjusted so that the resulting water mixture in the steam container has a desired conductivity. In other words, if the conductivity in the water within the steam container is above the desired level, less conductive water is introduced for replenishment, while in case of a conductivity below the desired value, water with higher conductivity is used for replenishment. The conductivity of the water used for replenishment may be adjusted by mixing water from two sources with different conductivity.

Preferably, the assessment of the conductivity of the water within the steam container is based on the observation of at least one system response during the normal operation of the electrode steam humidifier. The observation of system responses of the electrode steam humidifier generally allows the method being applied to already existing electrode steam humidifiers and electrode steam humidifier designs, without requiring structural changes. Often, only the controller of the electrode steam humidifier requires updating to allow observing the system responses and react thereto.

While the inventive method is preferably implemented in an inventive electrode steam humidifier, it is not limited to this specific embodiment. Rather, the inventive method might also be realized with a known electrode steam humidifier comprising a single water inlet and a source of water connected thereto, wherein the source of water is controllable in regard to the mineralization of the water provided to the electrode steam humidifier. An example for such a source of water is an osmosis unit for purifying mineralized water with a controllable bypass for mineralized water.

Consequently, while it is possible—and preferred—for the controller of the electrode steam humidifier to execute the inventive method, wherein an external controllable source of water may be controlled via a suitable interface, it is also possible for a separate controller to execute the inventive method. In this case, said separate controller must be provided with all readings necessary to execute said method and be configured to control electrode steam humidifier and all other possible components via suitable interfaces. In other words, the controller running the inventive computer program product needs to be connected to all required sensors and actuators of the electrode steam humidifier and all other possible components.

### BRIEF DESCRIPTION OF THE DRAWING

The invention will now be described in further detail in regard to the enclosed FIGURE. This shows:

FIG. 1: a schematic drawing of a first exemplary embodiment of an electrode steam humidifier according to the present invention.

### DETAILED DESCRIPTION

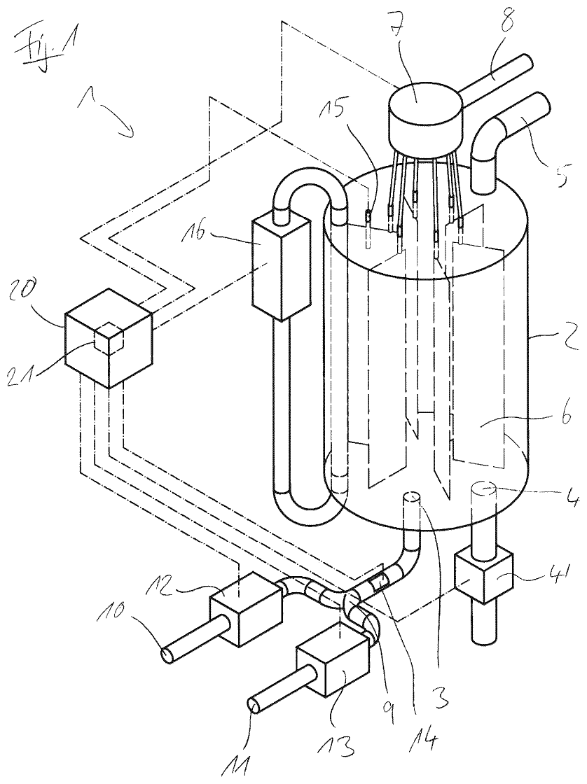

FIG. 1 schematically depicts an electrode steam humidifier 1 in accordance with the present invention. By elucidating said electrode steam humidifier 1, not only the inventive apparatus but also the inventive method become readily apparent.

The electrode steam humidifier comprises a steam container 1 comprises a steam container 2 in the form of a steam cylinder. The steam container 2 comprises an intake opening 3 as well as a drainage opening 4 with a controllable drainage pump 4′ in its bottom. At the top, there is a steam outlet 5, that leads to any other appliance at least temporarily requiring steam (not shown), e. g. climate control units.

Within the steam container 2 six electrodes 6 are disposed evenly spaced around the circumference. These electrodes 6 are configured to allow boiling up water with limited conductivity, thus having a large surface facing each other, in the present case approx. 20 cm²/A each. While the electrodes 6 are depicted as simple plate electrodes, they might have a somewhat more elaborate design, e.g. V-shaped, resulting in the surfaces of two adjacent electrodes 6 to show a constant distance over the whole area.

The electrodes 6 are individually electrically connected to a power distribution unit 7 connected to an external power source, e. g. a power grid (not shown), via connection line 8. Power distribution unit 7 is configured to supply the electrode with either direct or alternating voltage in a way that the potential of two adjacent electrodes 6 is different. Furthermore, the power distribution unit 7 measures the total electrical current flowing between the electrodes 6 and provides the facility to limit the current flow—and thus the electrical power consumed by the electrodes 6, assuming constant voltage—to an externally supplied setpoint.

Via a Y-connector 9, intake opening 3 is connected to two separate water inlets 10, 11, the throughflow thereto being controllable by, in this example, solenoid valves 12, 13. The first water inlet 10 is intended for mineralized water, usually tap water, while the other water inlet 11 is intended for demineralized water.

In the connection between the Y-connector 9 and the intake opening 3, a conductivity sensor 14 is provided to measure the conductivity of the water flowing through said connection.

The steam container 2 is also provided with a sensor electrode 15, protruding thereinto from the top by a predetermined length. Said sensor electrodes 15 indicates whether its tip is immersed into water or not.

In parallel to this, a water level detector 16 is provided. The water level detector 16, which is connected to the steam container 2 via communicating tubes, is a capacitive water level sensor, e.g. as disclosed in DE 20 2016 005 944 U1, and allows to precisely determine the water level within the steam container 2 in a range around the water level prescribed by the sensor electrode 15. The range is mainly defined by the length of the water level detector 16.

All sensor devices, i.e., the conductivity sensor 14, the sensor electrode 15, the water level detector 16 and the power distribution unit 7 in its capacity to measure the total electrical current, as well as all controllable devices, i.e., the various valves 12 and 13, the drainage pump 4′ as well as power distribution unit 7 in respect to its power limiting functionalities, are connected to a controller 20, which also comprises an observation module 21.

For operation, the steam container 2 is initially filled with water of a prescribed conductivity up to the water level prescribed by the sensor electrode 15 by opening the two solenoid valves 12, 13 of the two water inlets 10, 11, wherein the controller 20 opens each of the valves 12, 13 to an extent required to achieve a mixture with the desired conductivity. The prescribed conductivity of the inflowing water during the filling up is constantly monitored by via the conductivity sensor 14. In case of a deviation from the desired conductivity, the controller 20 is configured to adjust the valves 12, 13 and thus the mixture of mineralized and demineralized water to reach the desired conductivity.

Once the sensor electrode 15 and/or the water level detector 16 signal to the controller 20 that the prescribed water level has been reached, the vales 12, 13 are shut.

After the initial fill of the steam container 2 with water, the electrodes 6 are electrically energized by the power distribution unit 7 so that adjacent electrodes 6 are each of different potential to cause an electric current in the water due to its conductivity. The overall electric current is measured by the power distribution unit 7 and reported to the controller 20.

Due to the electric current running through the water, the water is heated up to boiling, thus generating steam that is output via the steam outlet 5. While heating up, the conductivity of the water increases, which is registrable by the power distribution unit 7 and the controller 20 by an increase in electric currents though the electrodes 6.

Due to the steam extraction, the water level within the steam container 2 decreases, which is noticeable by the sensor electrode 15 and/or the water level detector 16, and also generally leads to a decrease in electric current. The decrease in water level is registered by the controller 20 either by a combination of the sensor electrode 15 reporting the water level being below its tip and a decrease in electric currents by a predetermined amount or by the water level detector 16 and is generally countered by replenishing the steam container 2 with water from the first and/or second water inlet 10, 11.

Due to generated steam being generally pure, the mineral concentration in the water within the steam container 2 generally—although slowly—increases, which at first also contributes to an increase in conductivity. However, an increased mineralization might also lead to precipitating of mineral, which in turn lowers the overall conductivity of the water. With the intention of keeping the conductivity of the water within the steam container 2 at the prescribed/initial level, the controller 20 is configured to purposefully adjust the conductivity of the water inflow in order to control the conductivity of the resulting water mixture within the steam container 2.

For this, the controller 20 comprises an observer module 21 that is configured to assess the conductivity of the water within the steam container 2.

For example, the observer module 21 may observe the maximum electric current reached each time after the steam container 2 has been replenished with water as indicated by sensor electrode 15, which the maximum electric current reached after having heated up the water within the steam container 2 to boiling temperature. Any deviation from, e. g. the electric current measured during an initial heating cycle (see above), which might be regarded as a reference response of the system of the electrode steam humidifier 1, may be interpreted as a deviation of the conductivity of the water within the steam container 2, which may be countered by the controller 20 by adjusting the mixture of mineralized and demineralized water used for replenishing in according with a characteristic curve stored in the controller 20.

Alternatively, or in addition, the conductivity of the water within the steam container 2 might also be derived from the electric currents measured by the power distribution unit 7 and the water level detected by the water level detector 16. These findings might be compared to an expected standard system response stored within the controller and any deviation may be interpreted in a deviation from the desired conductivity of the water within the steam container 2. Again, said deviation may be countered by the controller 20 by adjusting the mixture of mineralized and demineralized water used for replenishing in according with a characteristic curve stored in the controller 20.

As the water mixture flowing into the steam container 2 is monitored regarding its conductivity by the conductivity sensor 14, the controller 20 and/or the observer module 21 might apply a machine learning algorithm based on said measures conductivity and the effects on the conductivity assessed for the water in the steam container 2.

In any case, using only one or both methods mentioned above, i. e. based on the sensor electrode 15 and the water level detector 16, the controller 20 generally achieves a constant level of mineralization of the water within the steam container 2 throughout operation of the electrode steam humidifier 1.

Even though because of this, the time periods between a full exchange of water in the steam container 2 as well as other maintenance cycles might be extended, from time to time, the steam container 2 needs to be fully flushed in order to wash away as many precipitating mineral accumulations as possible. For this, the controller 20 might activate the drainage pump 4′ to syphon the water from the steam container 2 through the drainage opening 4. Once the steam container 2 is emptied, said drainage pump 4′ is deactivated and the steam container 2 is refilled with water as described above.

The electrode steam humidifier 1 as shown in FIG. 1 may provide additional advantages:

Using both disclosed techniques of assessing the water level or at least the meeting of a prescribed water level, i.e. via the sensor electrode 15 and the water level detector 16, any foam formation within the steam container 2 can be detected since foam in the steam container 2 will usually trigger the sensor electrode 15 before the actual water level as detectable by the water level detector 16, which is generally not affected by foam forming in the steam container 2, has reached the tip of the sensor electrode 15. The forming of foam in the steam container 2 might indicate impurities or low quality of the water—often of the mineralized water, which is typically tap water—that might require more frequent maintenance and/or cleaning of the electrode steam humidifier 1 and especially the steam container 2 and the electrodes 6 to ensure long operation times of the electrode steam humidifier 1.

In order to reduce the variation in steam production, the controller 20 may also be configured to mitigate the increase in electric power that is conducted through the electrodes 6 by sending suitable control commands to the power distribution unit 7 as well as utilizing the water level detector 16 to keep the water level within the steam container 2 as close as possible to the desired water level as e. g. prescribed by the sensor electrode 15. Both measures help to keep the steam production of the electrode steam humidifier 1 more constant.

1. An electrode steam humidifier (1) comprising a steam container (2) with a first water inlet (10) for mineralized water and at least two electrodes (6) arranged to be at least partly immersed in water filled in above a minimum fill level, wherein the electrodes (6) are supplied with an electric voltage so that at least one of the electrodes (6) has a different potential than the other electrode(s) (6) to cause an electric current in the water,
wherein the steam container (2) comprises a second water inlet (11) for demineralized water and means to assess the conductivity of the water held within the steam container (2), wherein a throughflow through both water inlets (10, 11) for replenishing the steam container (2) is controlled by a controller (20) based on the assessed conductivity in order to obtain or maintain a desired conductivity of the water within the steam container (2).

2. The electrode steam humidifier of claim 1, wherein the means to assess the conductivity of the water held within the steam container (2) comprise an observer module (21) capable of observing at least one parameter of operation of the electrode steam humidifier (1) sufficient to assess said conductivity.

3. The electrode steam humidifier of claim 2, wherein the at least one parameter of operation comprises electric currents flowing though the electrodes (6).

4. The electrode Electrode-steam humidifier of claim 1, wherein a sensor electrode (15) is provided that indicates the water level within the steam container (2) being at or above a prescribed level.

5. The electrode steam humidifier of claim 1, wherein a water level detector (16) is provided, wherein said water level detector (16) is preferably arranged in a container separate from the steam container (2), wherein said containers form communicating vessels.

6. The electrode Electrode-steam humidifier of claim 1, wherein at least one conductivity sensor (14) is provided in the steam container (2), in a vessel communicating with the steam container (2), at one or both of the water inlets (10, 11) and/or at a position, where the two separate inlets (10, 11) are united to provide a combined inflow into the steam container (2) of already mixed water.

7. The electrode steam humidifier of claim 1, wherein a surface area of each of the electrodes (6) as a function of the rated current is between 5 and 30 cm²/A, preferably between 10 and 20 cm²/A for full-surface electrodes, or between 5 and 25 cm²/A, more preferably between 5 and 15 cm²/A for mesh electrodes, and/or the surface distance between two adjacent electrodes (6) with different potentials is between 25 and 50 mm for a maximum rated potential difference of 400V, between 15 and 35 mm for a maximum rated potential difference of 200V, or between 50 and 80 mm for a maximum rated potential difference of 690V.

8. The electrode steam humidifier of claim 1, wherein a solenoid valve (12, 13) is provided on the first and/or the second water inlet (10, 11) that is controllable by the controller (20).

9. The electrode steam humidifier according to of claim 1, wherein the electrode steam humidifier (1) comprises an interface to an external water treatment device connected to the second water inlet (11) to control the demineralized water output of the external water treatment device.

10. The electrode steam humidifier of claim 1, wherein the steam container (2) is a steam cylinder.

11. The electrode steam humidifier of claim 1, wherein the controller (20) is configured to regulate electric power that is conducted through the electrodes (6), to limit or mitigate an increase in electric current due to an increase in conductivity of the water within the steam container (2).

12. The electrode steam humidifier of claim 5, wherein the controller (20) is configured to control the first and second water inlet (10, 11) dependent on the water level detector (16) to keep a water level in the steam container (2) constant during operation.

13. A method for operating an electrode steam humidifier (1), wherein a conductivity of the water within a steam container (2) of the electrode steam humidifier (1) is assessed and a conductivity of water introduced into the steam container (2) for replenishment is adjusted so that a resulting water mixture in the steam container (2) has a desired conductivity.

14. The method of claim 13, wherein the assessment of the conductivity of the water within the steam container (2) is based on the observation of at least one system response during normal operation of the electrode steam humidifier.

15. A non-transitory computer readable medium comprising instructions that are designed, when loaded in a digital controller connected to the required sensors and actuators of at least an electrode steam humidifier (1), to execute the method of claim 13.
